(19) United States
(12) Patent Application Publication
(10) Pub. No.: US 2009/0107281 A1
(43) Pub. Date: Apr. 30, 2009

(54) Spring-based vectoring system for robotic aplications

(76) Inventors: Keenan A. Wyrobek, Menlo Park, CA (US); J. Kenneth Salisbury, JR., Mountain View, CA (US); Eric Berger, Mountain View, CA (US)

Correspondence Address: LUMEN PATENT FIRM, 2345 YALE STREET, SECOND FLOOR, PALO ALTO, CA, 94306, US

(21) Appl. No.: 12/154,112

(22) Filed: May 19, 2008

Related U.S. Application Data
(63) Continuation of application No. 11/904,181, filed on Sep. 25, 2007, now abandoned.
(60) Provisional application No. 60/847,313, filed on Sep. 25, 2006.

(51) Int. Cl. B25J 18/00

(52) U.S. Cl. 74/490.01

(57) ABSTRACT

An actuation system for a multi-segmented robot linkage is provided. The system includes (i) a gravity counter balancing mechanism for the multi-segmented robot linkage and a payload in contact with the multi-segmented robot linkage and (ii) a plurality of actuators acting on the joints of the multi-segmented robot linkage, whereby the actuators are high-bandwidth back-drivable actuators.

### CROSS-REFERENCE TO RELATED APPLICATIONS

This application is a continuation of U.S. non-provisional application Ser. No. 11/904,181 filed Sep. 25, 2007. U.S. non-provisional application Ser. No. 11/904,181 filed Sep. 25, 2007 claims priority from U.S. provisional patent application No. 60/847,313 filed Sep. 25, 2006. Both applications are incorporated herein by reference.

### FIELD OF THE INVENTION

The invention relates to robotics. In particular, the invention relates to new actuation mechanisms to exert a directed force controllable in both direction and magnitude.

### SUMMARY OF THE INVENTION

The key aspect of the invention is the development of a spring-based actuation system that is able to exert a directed force controllable in both direction and magnitude. The system could use springs and/or other passive kinematic elements to create adjustable static or slowly varying forces without significant steady-state expenditure of power.

The advantage of the invention is that robotic systems employed with the new actuation system can employ low-cost motors instead of high-performance motors and still be able to exert large forces. Another advantage of the invention is the use of high bandwidth back-drivable actuators. Since the output of the force vectoring system is inherently a force vector, the new actuation system is natively back-drivable. Yet another advantage is of the invention is the safer operation compared to traditional robots without employing force measurements and without introducing dependency of safety on sensors.

The invention is useful in for example situations where a load is lifted or must be held in place against gravity can benefit from the new actuation system. Another example where the invention is useful is in situations where a static or slowly varying force must be applied, such as holding a wallboard in alignment with wall-studs, or when a robot must apply steady fixation or assembly forces.

Application areas of the invention include personal robots, medical robots, humanoid robots, legged robots, manufacturing robots, assembly robots, construction robots, service robots, haptic devices or interfaces, and the like systems where force magnitude and direction both require control.

### DETAILED DESCRIPTION

Additional background and detailed description of embodiments of the invention are contained in the following appendix attached hereto:
Appendix A: A paper (86 pages) entitled “Robotic Systems Using Spring-Based Force Vectoring System” by Wyrobek et al.

1. An actuation system for a multi-segmented robot linkage, comprising:
(a) a gravity counter balancing mechanism for said multi-segmented robot linkage and a payload in contact with said multi-segmented robot linkage; and
(b) a plurality of actuators acting on the joints of said multi-segmented robot linkage, wherein said actuators are high-bandwidth back-drivable actuators.
